(19) United States
(12) Patent Application Publication
(10) Pub. No.: US 2013/0321892 A1
(43) Pub. Date: Dec. 5, 2013

(54) POSITIONING DEVICE FOR SCANNING A SURFACE

(71) Applicant: International Business Machines Corporation, Armonk, NY (US)

(72) Inventors: Walter Haeberle, Rueschlikon (CH); Angeliki Pantazi, Rueschlikon (CH); Abu Sebastian, Rueschlikon (CH); Tomas Tuma, Rueschlikon (CH)

(21) Appl. No.: 13/927,861

(22) Filed: Jun. 26, 2013

Related U.S. Application Data
(63) Continuation of application No. 13/900,731, filed on May 23, 2013.

(30) Foreign Application Priority Data
May 30, 2012 (GB) 1209595.6

(51) Int. Cl. G02B 26/10

(52) U.S. Cl. CPC G02B 26/10
USPC 359/221.3

(57) ABSTRACT

A positioning device for scanning a surface includes a movable element; at least one spring-like element having a resilience element for providing a tunable resilience in at least one direction; wherein the spring-like element is configured to tune the resilience by applying a force onto the resilience element of the at least one spring-like element.

### PRIORITY

This application is a continuation of U.S. patent application Ser. No.: 13/900,731, filed May 23, 2013, which claims priority to Great Britain Patent Application No. 1209595.6, filed May 30, 2012, and all the benefits accruing therefrom under 35 U.S.C. §119, the contents of which in its entirety are herein incorporated by reference.

### BACKGROUND

The present invention relates to devices for physically scanning a surface as used in applications such as data storage, semiconductor metrology, scanning probe microscopy and biology.

In scanning probe microscopy, scanners are used to position the material under investigation relative to an atomically sharp probe. The mechanical parameters of the scanner, such as the resonant frequency and the positioning range, are of key importance to the resulting position and speed. Conventionally, as known e. g. from documents G. Schitter et al.: “Design and modeling of a high-speed AFM-scanner, IEEE Transactions on Control Systems Technology”, 2007, K. Leang and A. J. Fleming: “High-speed serial-kinematic SPM scanner: design and drive considerations”, Asian journal of control, 2009, and B. Kenton and K. Leang: “Design and Control of a Three-Axis Serial-Kinematic High-Bandwidth Nanopositioner”, IEEE/ASME Transactions on Mechatronics, 2011, the mechanical design of the scanner is based on serial or parallel flexure kinetics and is optimized according to the particular application with a fixed resonant frequency.

Conventional positioning devices are usually configured to serve for a single-purpose mechanical design. Mechanical properties in such positioning devices cannot simply be changed to adapt the device to the constantly changing requirements of the respective application. For instance, in conventional positioning devices it is not possible to change the trade-off between the scanning range and the dominant resonant frequency. This limits the applicability of known positioning devices and often requires that multiple position devices are used during the instrumental operation. This approach is cost intensive and affects the reliability of the system.

U.S. Pat. No. 6,245,590 discloses a frequency-tunable resonant scanner, wherein the resonant frequency can be altered by adding a moving or migrating mass.

According to U.S. Pat. No. 6,882,462, a MEMs scanner may have a tunable resonant frequency that can be adjusted to conform to the rate at which image data is provided. In one embodiment of such a MEMs scanner, a primary oscillatory body carries a secondary mass that can move relative to the primary oscillatory body, thereby changing its moment of inertia. The changing moment of inertia changes the resonant frequency and can be controlled by an applied control signal. By monitoring movement of the oscillatory body and comparing the monitored movement to the desired scanning frequency, a control circuit generates the appropriate control signal to synchronize the scanning frequency to the input data rate.

In U.S. Pat. No. 4,874,215, it is disclosed that the natural resonant frequency of a resonant mechanical system can be altered by using a spring structure that includes a material whose elastic properties change with temperature, so that the resonant frequency can be tuned to a desired value by changing the temperature of at least part of the spring structure.

U.S. Pat. No. 4,959,568 discloses a mechanical system in which the stiffness of a magnetic spring can be altered by modulating the electric current flowing through a coil.

In U.S. Pat. No. 6,331,909 a mechanical device is disclosed comprising a frequency-tunable resonant scanner, wherein the resonant frequency can be altered by adapting a fluid pressure.

In U.S. Pat. No. 6,285,489 proposes the approach that the properties of an absorptive material can be altered by adjusting the concentration of a gas.

U.S. Pat. No. 8,045,444 discloses a method of controlling at least a movement of a positioner of a scanner, the method being performed in a controlled substantially vibration free environment. The controlling method comprises determining a first and second vibration resonance frequency range of the positioner and performing a main scan by a movement of the positioner in the first and second scan direction. The spatial positioning of the positioner in the first and second scan direction is controlled by a first and second feedback loop, respectively, wherein the controlling by the first and second feedback loop is essentially performed in the first and second resonance frequency range, respectively.

U.S. Patent Application Publication 2008/0165403 A1 discloses a light-deflecting apparatus having an oscillation system having an oscillation body, an elastic suspension, by means of which the oscillating body is oscillatory suspended, wherein the elastic suspension has at least two spring beams, an adjuster for adjusting the resonant frequency of the oscillation system by changing the position of the at least two spring beams of the elastic suspension to each other, wherein the oscillation body is a deflection mirror, and a drive for operating the oscillation system at the resonant frequency.

U.S. Pat. No. 4,797,749 shows a surface-scanning system that defines an optical path and has a scanning assembly comprised of X and Y angularly oscillating scanners for deflecting a portion of the path, and first and second optical elements aligned with stationary portions of the optical path and driven in rectilinear oscillating motion along the path to provide focus correction respectively for the X and Y scanners. The X direction scanner is of the resonant type and has a mechanism for dynamically tuning its resonant frequency, the first optical element is mounted to oscillate in rectilinear resonant motion, and the tuning mechanism of the X direction scanner is arranged to receive a signal representing the oscillations of the first optical element and to tune the resonant frequency of the X direction scanner to synchronize its resonant motion with that of the first optical element.

### SUMMARY

In one embodiment, a positioning device for scanning a surface includes a movable element; at least one spring-like element having a resilience element for providing a tunable resilience in at least one direction; wherein the spring-like element is configured to tune the resilience by applying a force onto the resilience element of the at least one spring-like element.

In another embodiment, a method for operating a positioning device for scanning a surface, the positioning device having a movable element, and at least one spring-like element having a resilience element configured to provide a tunable resilience in at least one direction, wherein the spring-like element is configured to tune the resilience by applying a force onto the resilience element of the at least one spring-like element, includes driving the movable element is driven by an actuator, wherein the actuation is performed with an actuation frequency, wherein the resonant frequency of a system comprising the movable element and the at least one spring-like element in the at least one direction is tuned, by tuning the resilience of the resilience element, to adapt an oscillating behavior of the system.

### BRIEF DESCRIPTION OF THE SEVERAL VIEWS OF THE DRAWINGS

Exemplary embodiments of the present invention are described in more detail in conjunction with the accompanying drawings, in which:

FIG. 1 basically illustrates a table scanner as a positioning device for two-dimensional scanning;

FIG. 2 schematically shows the support of the scanning table of FIG. 1 by means of springs;

FIG. 3 shows an illustration of a specific embodiment for a biased beam having a variable stiffness;

FIG. 4 shows an exemplary embodiment of a positioning device having a scanning table which is coupled to a tunable spring.

### DETAILED DESCRIPTION

It is an aspect of the present invention to provide a positioning device with means for tuning the resonant frequency over a broad range and a quick timely response.

According to the first aspect a positioning device for scanning a surface is provided, including a movable element; at least one spring-like element having a resilience element for providing a tunable resilience in at least one direction; wherein the at least one spring-like element is configured to tune the resilience by applying a force onto the resilience element of the at least spring-like element.

One idea of the above positioning device is to utilize a spring or a spring-like element having a resilience element with a tunable resilience i.e. a variable stiffness which can be tuned by external means. By applying the variable stiffness spring-like element to the movable element of the positioning device, its mechanical and dynamical properties can be altered. Since springs usually can be incorporated in any existing design, either in the form of a flexure design or as an external spring attached to the movable element, existing appliances can be equipped and thereby configured to cover a broader range of mechanical properties, thereby affecting position and speed.

It may be provided at least an additional spring or spring-like element for providing a fixed resilience in at least one direction.

Furthermore, the resilience element of the further spring-like element may include a membrane, a beam, a cantilever and/or a coil.

It may be provided that the resilience element is configured that its spring constant or resilience, respectively, is changed when a deforming force is applied thereon.

According to an embodiment a tuning element may be provided for applying the force onto the resilience element.

Moreover, the tuning element comprises a tip for applying the force onto the resilience element.

The tuning element may be coupled with a setting element for displacing the tuning element wherein the force is developed by the displacement of the resilience element.

According to an embodiment of a further aspect the use of a further spring-like element having a resilience element is provided in a positioning device for scanning a surface, wherein the resilience element has a tunable resilience in response to a displacement by a tuning element.

According to an embodiment of a further aspect the use of a tuning element is provided in a positioning device for scanning a surface, wherein the tuning element is configured to be displaced, wherein depending on its displacement a force is developed on a resilience element which deflects the resilience element wherein the resilience element has a spring constant which is depending on the deflection.

According to an embodiment of a further aspect a method for setting a mechanical property of a positioning device is provided, that has a movable element which is resiliently supported by at least one element, wherein a force is applied to the at least one element.

According to an embodiment of a further aspect, a method for operating the above positioning device for scanning a surface, wherein the movable element is driven by means of an actuator, wherein the actuation is performed with an actuation frequency, in particular a constant actuation frequency, wherein the resonant frequency of the system comprising the movable element and the at least one spring or spring-like element in the at least one direction is tuned, by tuning the resilience of the resilience element, to adapt an oscillating behavior of the system.

Furthermore, it may be provided that the actuation is performed with an actuation frequency being different from a resonant frequency of the system consisting of the movable element and the at least one spring or spring-like element in the at least one direction.

In particular, the actuation may be performed such that the movable element is moved in a large-range at low frequency, and in a short-range at high frequency, by tuning the resilience of the tunable resilience element.

Moreover, the resonant frequency of the system consisting of the movable element and the at least one spring-like element in the at least one direction may be tuned to be equal to the actuation frequency, by tuning the resilience of the resilience element. Hence, the resonant frequency of the system is changed in order to meet the requirements imposed by the scan trajectory. For instance, the resonant frequency of the system can be set to meet the actuation frequency of a Lissajous trajectory.

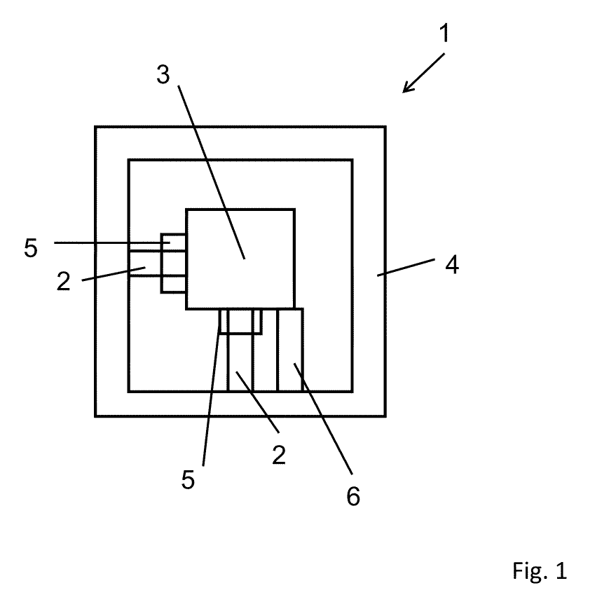

FIG. 1 schematically shows a positioning device 1 having a scanning table 3 which is supported by springs 2 on a frame 4. The springs 2 provide resiliency in two directions perpendicular to each other. The springs 2 are arranged between the frame 4 and the scanning table 3 (movable element) wherein the frame encompasses the scanning table 3.

Actuators 5 are coupled with the scanning table 3 in order to drive a periodic movement of the scanning table 3 by applying a periodically changing force. Actuators 5 can be based on applying magnetic or electrical forces onto the scanning table 3.

The actuation of the scanning table 3 may be performed in at least one direction, and more specifically in both directions. Scanning range and scanning speed are substantially influenced by the resilience and by the resonant frequencies of the mechanical system, respectively. In one embodiment of a mechanical system, the scanning table can be used for large-range, low frequency scanning and short-range, high frequency scanning by tuning the resilience of the tunable resilience element.

In another embodiment, the movement of the scanning table 3 is substantially sinusoidal and its frequency may correspond to a resonant frequency of the mechanical system in that specific direction. Such an arrangement results in a movement pattern of the scanning table 3 which may correspond to a specific non-raster scan trajectory, such as a spiral, cycloid, Lissajous or other trajectory covering the area to be scanned by the scanning table 3.

The springs 2 for supporting the scanning table 3 may be implemented by spring-like mechanical elements providing a specific resiliency or stiffness (spring constant). The spring like elements can be beams, membranes, cantilevers, coil structures or the like. In the mechanical system provided by the positioning device 1 of the present invention, the stiffness of the spring-like element substantially determines the mechanical properties of the positioning device, in particular its dynamic response behavior and its resonant frequency.

One aspect of the present invention embodiments is to use or to add at least one further spring 6 having a tunable stiffness (tunable spring constant) or a tunable resiliency.

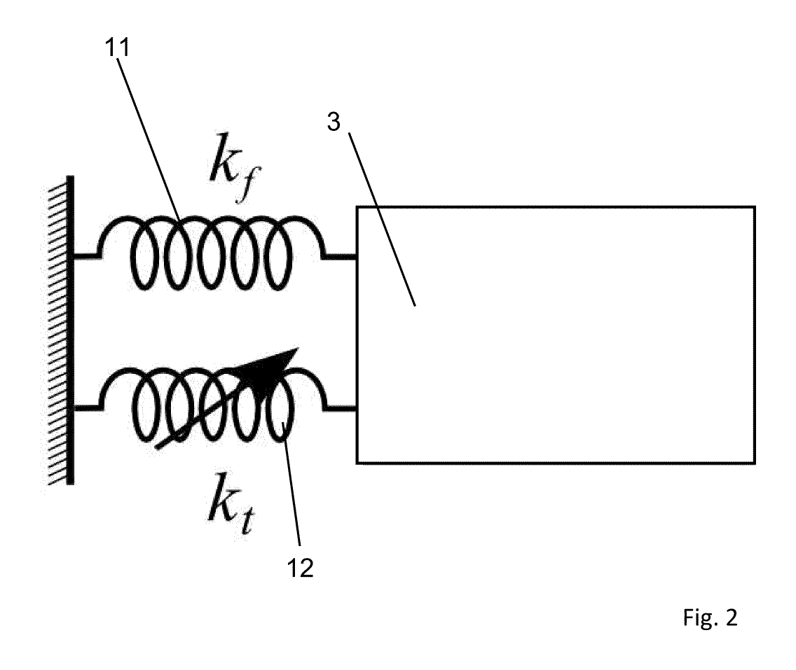

As shown in the schematic illustration of FIG. 2, the scanning table 3 is supported by a first spring-like element 11 represented by the spring 2 having a fixed spring constant k_{f} and a parallel second spring-like element 12 represented by the further spring 6 having a tunable spring constant kₜ.

While the first spring-like element 11 serves for holding the scanning table 3, the tunable second spring-like element 12 is used for adapting the resonant frequency to the scanning purpose.

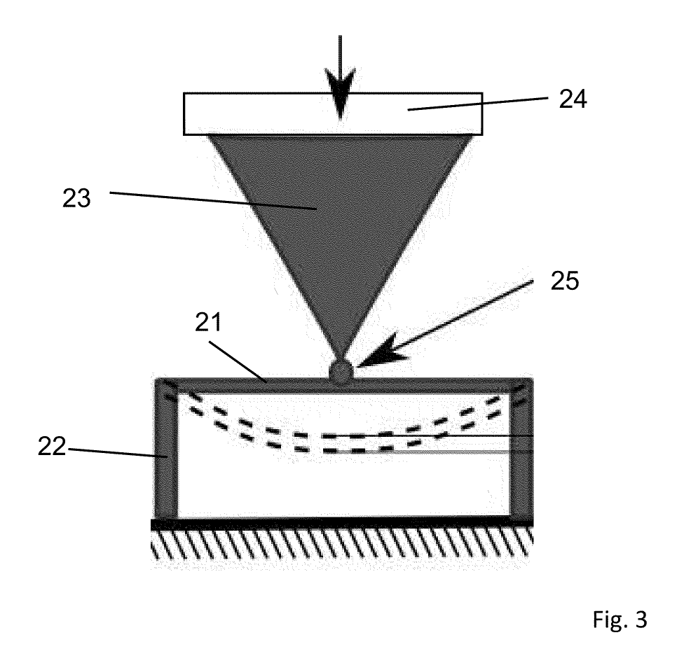

FIG. 3 shows an exemplary configuration of a tunable spring 12 to be implemented in or to be added to microsystems. The tunable spring 12 has a beam 21 both ends of which are supported by support elements 22. The support elements 22 are fixedly coupled to the scanning table 3. The beam 21 can be bent in the direction of the scanning table 3 to some extent by applying a respective force F. Depending on the force applied the stiffness of the beam 21 varies.

By means of a tuning element 23 that comprises a tip 25, a force can be applied onto the beam 21, such that the beam 21 is bent or pre-stressed towards the scanning table 3, respectively. Thereby, the spring constant or stiffness of the beam 21 is increased. By setting the force to be applied onto the beam 21 or by setting the position of the tip 25 of the tuning element 23, the degree of pre-stressing the beam 21 can be set, so that the stiffness can be tuned as desired.

The tuning elements 23 can be set manually or a force-applying element 24 can be coupled to the tuning element 23, such as an electrically controlled piezo element. The piezo element 24 allows for moving the tuning element 23 on application of an electrical voltage, such that the tuning element 23 is pushed towards the beam 21 and the beam 21 is pre-stressed in response to a voltage applied onto the piezo element.

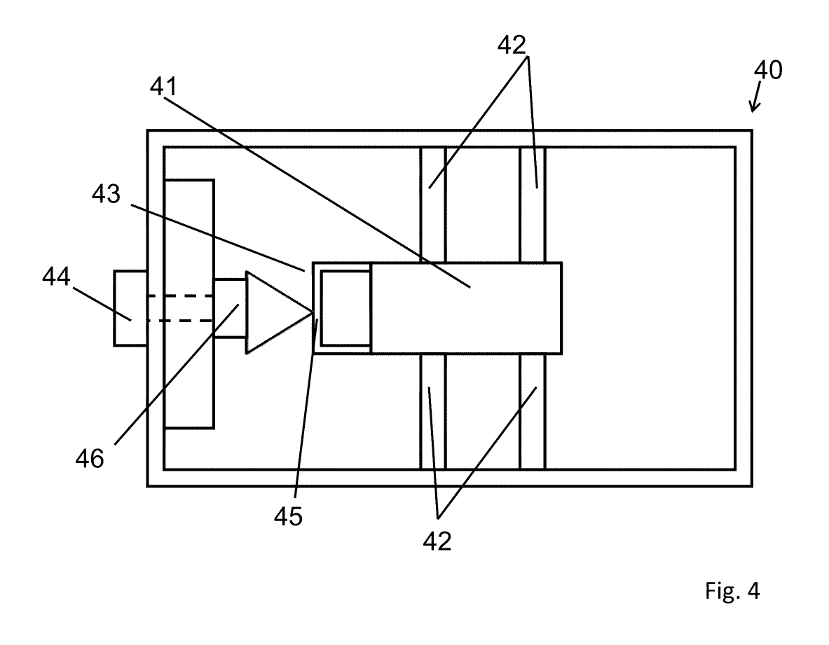

FIG. 4 shows, as an example, a top view onto a positioning device 40, wherein a scanning table 41 is supported by multiple support elements 42 in one direction and is coupled to a tunable spring 43 in another direction. The multiple support elements 42 may provide a resilience or stiffness in the one direction and in a direction perpendicular thereto. Above configuration results in a mechanical system having the behavior as illustrated in FIG. 2.

The tunable spring 43 has a beam 45 as a resilience element which can be pre-stressed with a screw 44 which may be coupled via the piezo element 46 to the tunable spring 43. The tip 47 of the tunable spring 43 pre-stresses the beam 45 which is coupled to the scanning table 41.

Such a configuration allows for adapting the resonant frequency of the scanning table 41 in a specific range and can be adapted during measurement in order to allow the real-time reconfiguration of the mechanical system.

1. A positioning device for scanning a surface, comprising:
a movable element;
at least one spring-like element having a resilience element configured to provide a tunable resilience in at least one direction;
wherein the spring-like element is configured to tune the resilience by applying a force onto the resilience element of the at least one spring-like element.

2. The positioning device of claim 1, further comprising at least one additional spring-like element configured to provide a fixed resilience in at least one direction.

3. The positioning device of claim 1, wherein the resilience element of the at least one spring-like element includes a membrane, a beam, a cantilever and/or a coil.

4. The positioning device of claim 1, wherein the resilience element is configured that its spring constant or resilience, respectively, varies when a deforming force is applied thereon.

5. The positioning device of claim 1, further comprising a tuning element configured to apply the force onto the resilience element.

6. The positioning device of claim 5, wherein the tuning element comprises a tip configured to apply the force onto the resilience element.

7. The positioning device of claim 5, wherein the tuning element is coupled with a setting element configured to displace the tuning element, so that the force is developed by the displacement of the resilience element.

8. The positioning device of claim 7, wherein the setting element comprises a piezoelectric actuator configured to control the displacement of the tuning element by electrical means.
